(19) United States
(12) Patent Application Publication
(10) Pub. No.: US 2021/0264541 A1
(43) Pub. Date: Aug. 26, 2021

(54) COMMUNITY WATCH WITH BOT BASED UNIFIED SOCIAL NETWORK GROUPS

(71) Applicants: JUN LI, Richmond Hill (CA); WEIXING LI, Richmond Hill (CA)

(72) Inventors: JUN LI, Richmond Hill (CA); WEIXING LI, Richmond Hill (CA)

(21) Appl. No.: 17/254,852

(22) PCT Filed: Jun. 22, 2018
(86) PCT No.: PCT/US2018/038922

§ 371 Date: Dec. 21, 2020

(51) Int. Cl. G06Q 50/00; G06N 3/08; H04L 12/58

(52) U.S. Cl. CPC G06Q 50/01; H04L 51/32; G06N 3/08

(57) ABSTRACT

The present disclosure includes the methods, processes, and systems of a novel community watch with bot-based unified social network groups. The new community watch comprises chatbots, artificial intelligence (AI) engine, social network messaging platforms used by community watch groups with security services based on identity recognition technology and physical threat intelligent information technology. This process turns meaningless text, sensor data, images and videos into context-based physical security information to be analyzed by the/a physical security information and event management system. The analyzed messaging platforms and varieties of activity options. The various said groups in the heterogeneous social networking and messaging platforms are combined and fused into the unified social network groups through the bots. The present disclosure nicely adapts and integrates new technologies and modern society. The bots and unified social network groups allow users to easily and intuitively use and interact with the community watch system, so the improved process and system can be more widely established, used, and made more effective in adding community security and protecting people.

### FIELD OF THE INVENTION

The present disclosure is in the field of security, security management system, physical security, neighborhood watch, community watch, artificial intelligence, facial recognition, pattern recognition, deep learning, bot, messaging system, social networks, and database.

### BACKGROUND

There was a rise in home break-ins in neighborhoods across Canada and the U.S.A. Most happened in broad daylight too. Of course the local police force needs to take more action, but prevention is far better than handling the crime after it actually happens and taking the damage.

One effective preventative measure is implementing a neighborhood watch or community watch program, which began in the 1960s. In the present disclosure from this point on, we will use the terms “neighborhood watch” and “community watch” interchangeably. When we refer to “neighborhood watch”, it also includes the “community watch”, and vise versa.

A traditional neighborhood watch, community watch, block watch, or crime watch program, managed nationally by the National Sheriffs' Association with help from the Department of Justice and local law enforcement, focuses on “eyes-and-ears” training for neighborhoods. Signs posted around the neighborhood also help deter would-be criminals. Communities involved in these programs work with local police. Community watch programs are created mainly around the concept of getting to know one's neighbors. This helps in sharing information and becoming better equipped to look for signs of suspicious activity. They vary from one community to the next, but typically use one of two main approaches: opportunity reduction, use of observation to spot and eliminate potential opportunities for criminal activity and restore the sense of community ownership; social problems, use of educational programs and other activities to raise awareness and target the root causes of crime (such as drug awareness programs, tutoring, sports clubs, etc.).

However traditional community watch programs are not well-equipped in many communities due to the inconvenience and inefficiency arising from their processes and structures. And for the most part, they are not adapted to new technologies and modern society. There is a need for a better system, that is, a comprehensive program to leverage all possible resources, especially modern resources, to form an end-to-end proactive security system. The resources are, but are not limited to, the neighborhood watch program, community watch, government, police force, crime stopper program, security devices, security equipment vendors, security management systems, physical security information and event management; as well as the new and modern resources like chat bot services and interfaces, voice and text messaging systems, social networks, Internet, cloud storage and databases, modern IoT (Internet of things) devices, sensor monitoring services, artificial intelligence, facial recognition, pattern recognition, and deep learning.

Today, social networks have become a popular resource for many people to stay in touch with friends and getting various sources of information. In addition to sharing information through these social networks, a person may also share photos and messages with others through email, or through Short Message Service (SMS-text messaging). People are already used to checking and communicating on those modern networking platforms, and using the social network software. It would be hard to ask them starting to use another dedicated software just for community watching only.

The present disclosure describes the method, process, and system of a novel community watch with bot-based unified social network groups. A bot, chatbot, or artificial conversational entity, is a computer program or artificial intelligence (AI), which conducts a conversation via auditory or textual methods. Such programs are often designed to convincingly simulate how a human would behave as a conversational partner. Such a new community watch nicely adapts and integrates the new technologies and modern society. It allows users to easily and intuitively use and interact with the system, so the improved community watch process and system can be more widely used and made more effective in adding community security and protecting people.

### SUMMARY

The present disclosure includes the methods, processes, and systems of a novel community watch with bot-based unified social network groups. The new community watch comprises chatbots, artificial intelligence (AI) engine, social network messaging platforms used by community watch groups with security services based on identity recognition technology and physical threat intelligent information technology. This process turns meaningless text, sensor data, images and videos into context-based physical security information to be analyzed by the/a physical security information and event management system. The analyzed information including the threat severity scores will be sent back to social messaging platforms and varieties of activity options. The various said groups in the heterogeneous social networking and messaging platforms are combined and fused into the unified social network groups through the bots. The present disclosure nicely adapts and integrates new technologies and modern society. The bots and unified social network groups allow users to easily and intuitively use and interact with the community watch system, so the improved process and system can be more widely established, used, and made more effective in adding community security and protecting people.

### BRIEF DESCRIPTION OF THE DRAWINGS

FIG. 1 illustrates the high level structure of the new community watch system with bot-based unified social network groups of the present disclosure; where the bot and its API are linked with an artificial intelligent engine and databases.

FIG. 2 illustrates a preferred embodiment of the present disclosure; where the underlying high-level system structure and data flow of the unified social network groups are presented.

FIG. 3 illustrates a preferred embodiment of the present disclosure; where the underlying high-level structure and data flow of the artificial intelligence and databases are presented.

FIG. 4 illustrates a preferred embodiment of the method or process of how the unified social network groups of the present disclosure are created.

FIG. 5 illustrates an exemplary embodiment of the data and processing flow of the artificial intelligent engine and its databases of the present disclosure.

FIG. 6 illustrates an exemplary embodiment of the block diagram of the core engine of the present disclosure.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention, and is not intended to limit the invention to the specific embodiments illustrated by the figures or description below. The present invention will now be described by referencing the appended figures representing preferred embodiments.

The present disclosure discusses the methods, processes and systems of a novel community watch with bot-based unified social network groups. The new community watch comprises artificial intelligence (AI) chatbots and social network messaging platforms used by community watch groups with security services based on identity recognition technology and physical threat intelligent information technology. This process turns meaningless images and videos into context based physical security information to be analyzed by the/a physical security information and event management system. The analyzed information will be sent back to social messaging platforms and varieties of activity options. The various said groups in the heterogeneous social networking and messaging platforms are combined and fused into the unified social network groups through the bots. The present disclosure nicely adapts and integrates new technologies and modern society. The bots and unified social network groups allow users to easily and intuitively use and interact with the community watch system, so the improved process and system can be more widely established, used, and made more effective in adding community security and protecting people.

In the present disclosure, since our unified community watch group will be always in the form of a social network group on multiple social network platforms, from this point on in our discussion, we will use the terms “unified community watch group” and “unified social network group” interchangeably according to which aspect of the unified group we focus on in the explanation.

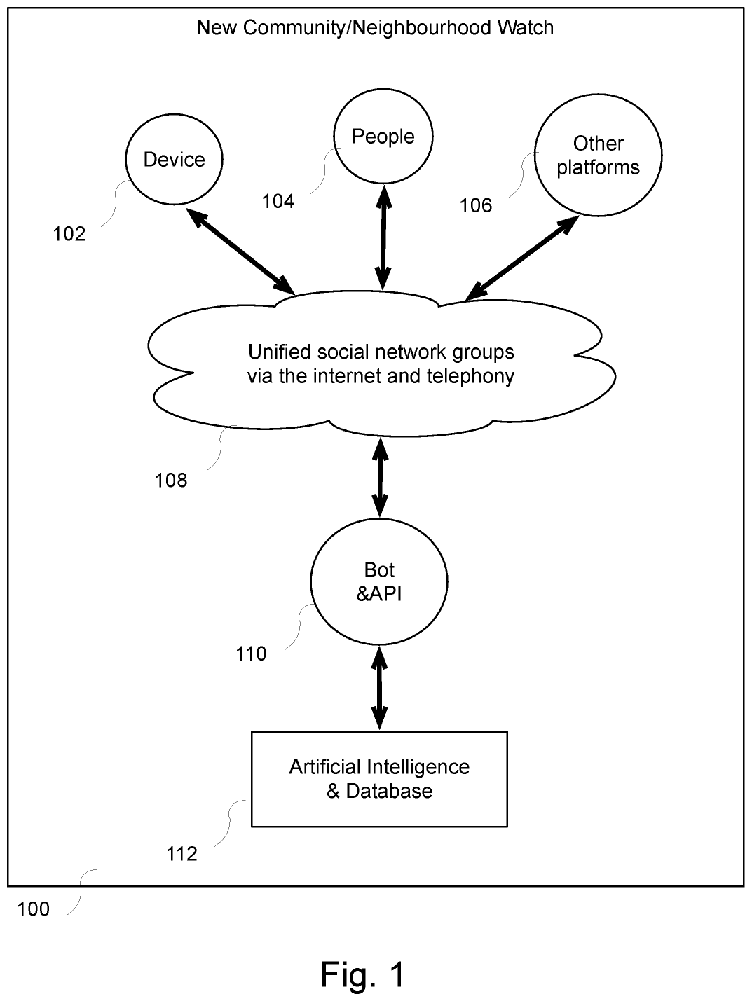

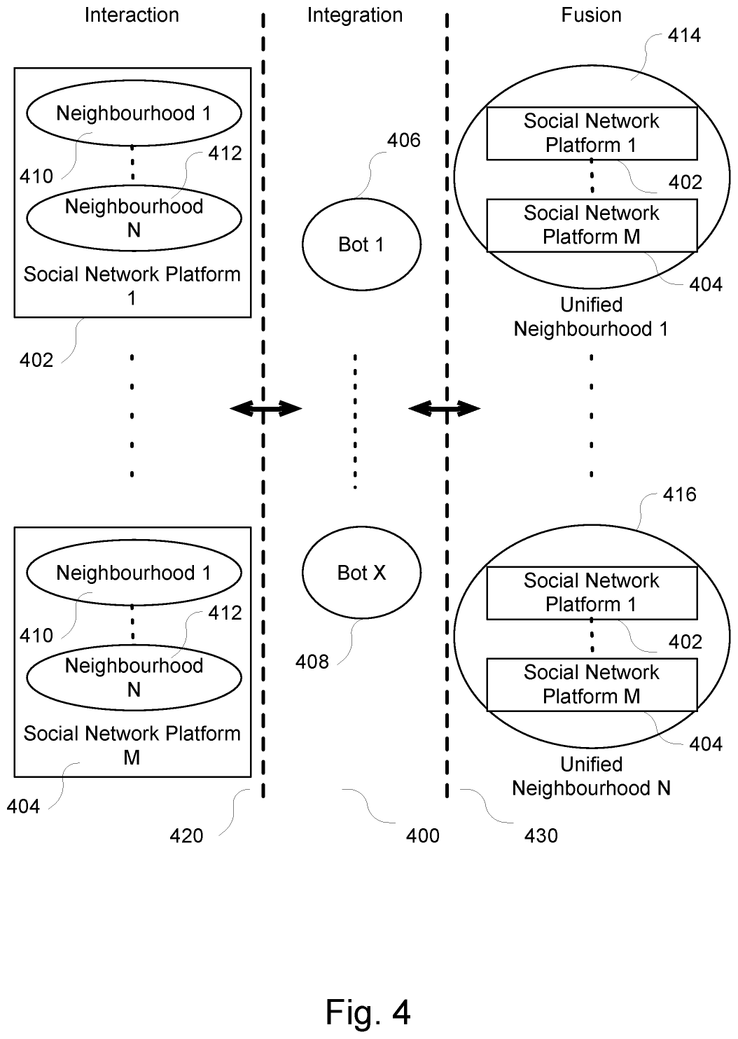

FIG. 1 illustrates the high-level structure of a new community watch method, process, and system with bot-based unified social network groups of the present disclosure. The new community watch (100) comprises the data input/output components (102, 104, 106, 108, 110) and the data analysis components (112). The data input/output components are parts of the interaction engine. The data analysis components (112) are parts of the core engine. All the data input and output components are connected through the Internet or telephony networks in the form of unified social network groups (108). The Internet includes WAN, LAN, WIFI and cellular 2G, GPRS, 3G, LTE, and 5G data services. The telephony networks include land lines, wireless PBXs, and cellular phone calls. The unified social network groups are abstract virtual people groups transparent to the underlying social network platforms and physical layer telecommunication infrastructures. We will elaborate the unified social network platforms (108) further in the FIG. 4.

The first input and output component of the unified social network groups (108) as well as the new community watch (100) is the device (102). Examples of the device are, but are not limited to, CCTV surveillance cameras, security IP cameras, alarm sensors, locks, doorbells, doorbell communication systems, lamps, etc. If there is any event triggered by the smart features such as motion detection, cross line detection, intrusion detection, etc., these devices will automatically send one or more detected images, videos, audio, texts, lights, or other format of signals or information to the unified social network groups and community watch; and will receive responses from the unified social network groups and community watch; for example, a doorbell communication system passes the audio signal from the social network groups back to the device's speaker.

The second input and output component of the unified social network groups (108) as well as the new community watch (100) is the people (104). The people are the social network group users of the community watch. They transmit vocal, visual, or text messages to the unified social network groups and community watch; and receive responses from the unified social network groups and community watch; for example, a text message reply is sent back to the user from the other user, device, bot, or other input/output component of the system.

The third input and output component of the unified social network groups (108) as well as the new community watch (100) is the other platforms (106). Examples of the other platforms are, but are not limited to, another community watch system, another public safety group, or any other third party messaging or networking systems. The other community watch systems or 3^{rd} party platforms transmit vocal, visual, or text messages to the current unified social network groups and community watch; and receive responses from the current unified social network groups and community watch; for example, a text message reply is sent to the user of the other community watch systems or 3^{rd} party platforms from the user, device, bot, or other input/output component of the current community watch system.

The fourth input and output component of the unified social network groups (108) as well as the new community watch (100) is the bot (110). The bot here includes, but is not limited to, the chatbots, broadcasting bots, automatic answering bots, and other bots used in the messaging systems and social media networks. A chatbot is a system that understands language and has intelligence about a certain context in a way that he can interact with the user to solve a certain problem. Examples of the bots are, but are not limited to, Twitterbots, Facebook messenger bots, and Wechat bots. Each bot may also provide a set of APIs (application programming interface) for other software to interact with over the Internet. The bots or the bot APIs receive and pre-process the user inputs, then transmit them to the artificial intelligence & database, or core engine (112) for further processing. After the core engine (112) processes the information, and generates the results, it will send it back to the bot and API (110). The bot and API will relay the processing results back to the input and output components (102, 104, 106) through the unified social network groups (108), which run physically on the Internet, telephony, mobile telephony, or cellular systems.

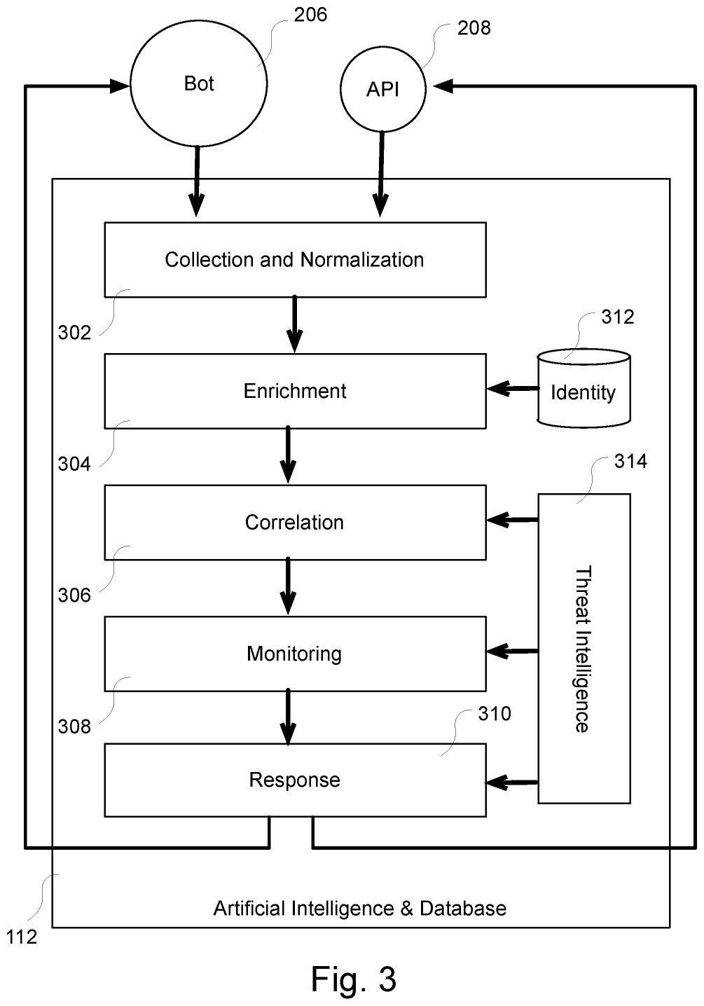

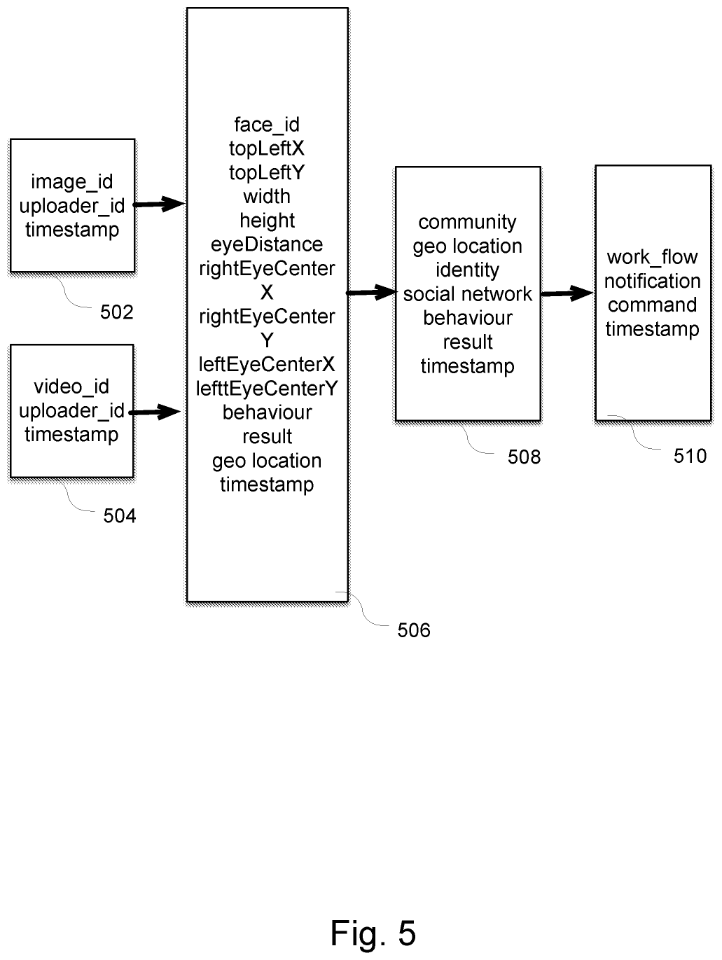

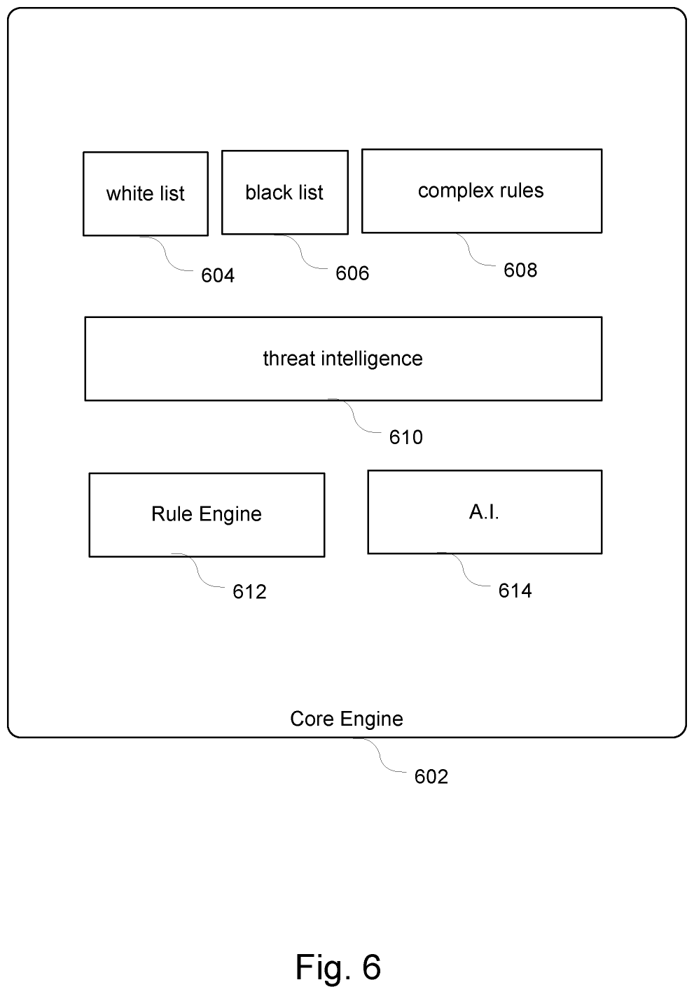

The artificial intelligence system & database, or core engine (112) is made up of, but is not limited to, the physical security information and event management system, monitoring services, and output services which send the analyzed information and action options. More details of the components, structures and functions will be discussed in the description of FIG. 3, FIG. 5, and FIG. 6.

In FIG. 1, the present disclosure describes a new community watch process involving a bot-based social networking and messaging platform that implements the novel unified social network groups. The process can integrate a messaging platform based community watch group with security services with identity recognition technology and physical threat-intelligent information technology. The latter turns meaningless images and videos into context-based physical security information including the security severity scores to be handled by a physical security information and event management system.

The first unique advantage of such a system is that the bot-based social network neighborhood group integration enables a natural and effective interaction between the end users and the security devices and services. The chatbot provides intuitive human-machine interaction. There is no need for users to download another mobile application in order to use the neighborhood series. All that is required from the users is to use their current favorite messaging and social networking tool to connect their current community watch group with the new community watch services. Using existing messaging tools is a non-intrusive and quick adoption path to the new community watch program.

The second advantage of such a system is that the different social network groups across different social network platforms can be fused to create unified neighborhood groups to enable wider and quicker adoption from people with different backgrounds and technology preferences. This is called social network group fusion. In such way, the new community watch service provides the bridging and broadcasting capability for messaging channels either in the same technology platform or across different technology platforms. Users only need to be aware of the single fused and unified neighborhood group they are in and do not care that the fused group is actually a combination of a few groups residing on two or more different software platforms and/or two or more different hardware platforms. This greatly enhances the community watch groups and simplifies the usage.

The third advantage of such a system is that at the neighborhood community level, we can dynamically measure the threat level based on the physical threat modeling. The new community watch process builds a closed loop measuring process to empower a traditional community watch program to better fight against crime in today's complicated society.

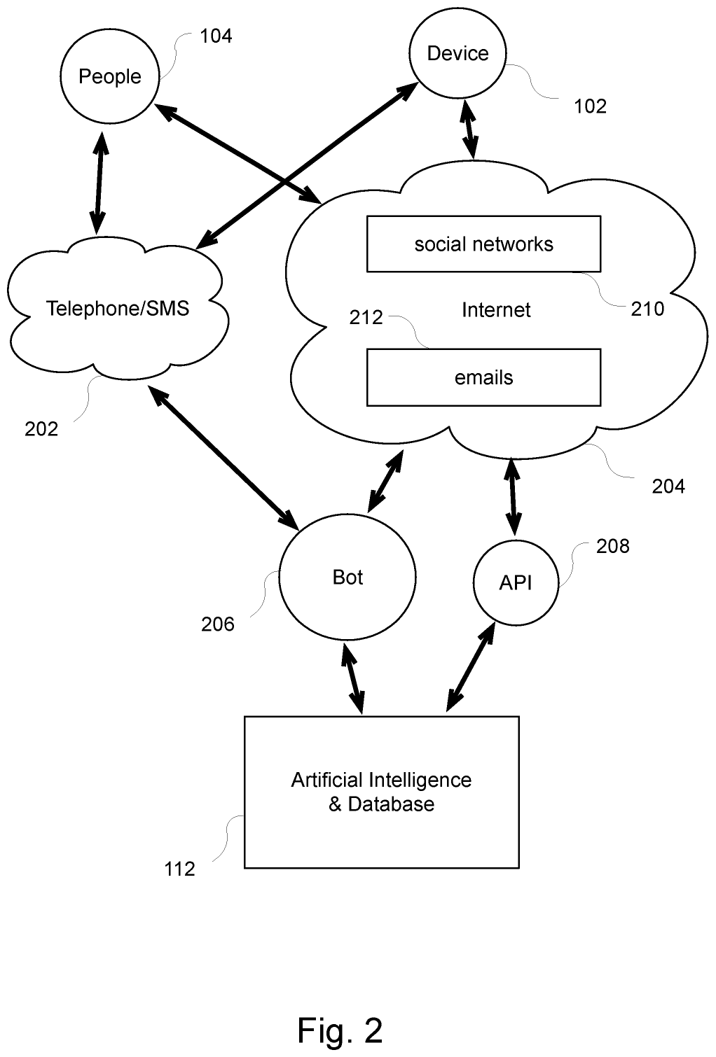

FIG. 2 illustrates a preferred embodiment of the present disclosure; where the underlying high-level system structure and data flow of the unified social network groups are presented. The device (102), the people (104), the artificial intelligence & database (112) are the same as described in FIG. 1. The previous unified social network groups via the Internet and telephony (108) and the bot &API (110) are expanded on with the details in system level structure and data flows. The unified social network groups' block (108) is split into two blobs according to the underlying physical communication platforms. One is the Telephone/SMS platform (202); another is the Internet (204). The Bot &API (110) is further divided into the Bot (206) and the API (208).

The Telephone/SMS platform (202) refers to the land telephony, mobile telephony, and cellular infrastructures and services. It normally includes the vocal communication and text messaging (SMS) services between people, as well as limited data and multimedia (like images and videos) transmission services. It covers the analog and digital telephony services, but not the IP telephony services. For example, the voice-over-ip telephone/SMS services are not included here.

The Internet (204) refers to the global system of interconnected computer networks that use the Internet protocol suite (TCP/IP) to link devices worldwide. It is a network of networks that consists of private, public, academic, business, and government networks of a local to global scope, linked by a broad array of electronic, wireless, and optical networking technologies. The Internet carries a vast range of information resources and services, such as the inter-linked hypertext documents and applications of the World Wide Web (WWW), electronic mail, telephony, and file sharing.

The people input/output component (104) will communicate with the Bot (206) through the Telephone/SMS (202) platform. At the same time, the people component (104) will also communicates with the Bot (206) through the Internet platform (204). The device input/output component (102) will communicate with the Bot (206) through the Telephone/SMS (202) platform. At the same time, the device component (102) will also communicates with the Bot (206) through the Internet platform (204). The device input/output component (102) will communicate with the API (208) through the Telephones/SMS (202) platform. At the same time, the device component (102) will also communicates with the API (208) through the Internet platform (204).

On the Internet platform (204), there runs social network (210) and email services (212) in the present preferred embodiment of the invention. A social networking service (social networking site, SNS or social media) is a web application that people use to build social networks or relations with other people who share similar personal or professional interests, activities, backgrounds or real-life connections. The variety of stand-alone and built-in social networking services currently available online introduces challenges of definition; however, some common features exist: (1) social networking services are Internet-based applications; (2) user-generated content (UGC) is the lifeblood of SNS organizations. Most social-network services are web-based and provide means for users to interact over the Internet, such as by e-mail, instant messaging and online forums. Social networking sites are varied. They can incorporate a range of new information and communication tools, operating on desktops, laptops, and mobile devices such as tablet computers and smartphones. They may feature digital photo/video/sharing and “web logging” diary entries online (blogging). Online community services are sometimes considered as/to be social-network services, though in a broader sense, a social-network service usually provides an individual-centered service, whereas online community services are group-centered. Defined as “websites or mobile applications that facilitate the building of a network of contacts in order to exchange various types of content online,” social networking services provide a space for interaction to continue beyond in person interactions. These computers mediated interactions link members of various networks and may help to both maintain and develop new social ties. Social networking sites allow users to share ideas, digital photos and videos, posts, and to inform others about online or real-world activities and events with people in their network. While in-person social networking—such as gathering in a village market to talk about events—has existed since the earliest development of towns, the Web enables people to connect with others who live in different locations, ranging from across a city to across the world. Depending on the social media platform, members may be able to contact any other member. In other cases, members can contact anyone they have a connection to, and subsequently anyone that contact has a connection to, and so on. The success of social networking services can be seen in their dominance in society today, with Facebook having a massive 2.13 billion active monthly users and an average of 1.4 billion daily active users in 2017. LinkedIn, a career-oriented social-networking service, generally requires that a member personally know another member in real life before they contact them online. Some services require members to have a preexisting connection to contact other members.

Electronic mail (email or e-mail) (212) is a method of exchanging messages (“mail”) between people using electronic devices. Email first entered limited use in the 1960s and by the mid-1970s had taken the form now recognized as email. Email operates across computer networks, which today is primarily the Internet. Some early email systems required the author and the recipient to both be online at the same time, in common with instant messaging. Today's email systems are based on a store-and-forward model. Email servers accept, forward, deliver, and store messages. Neither the users nor their computers are required to be online simultaneously; they need to connect only briefly, typically to a mail server or a webmail interface, for as long as it takes to send or receive messages.

So in one embodiment of the present disclosure the communication among the device (102), people (104), bot (206) and API (208) can be realized through the social networks (210) or email services (212). For example, people (104) or the device (102) shares a piece of information onto the social network (210) or emails (212), the bot (206) or API (208) receives the shared information and sends it to the core engine (112) for further processing. The processed result is retrieved back from the core engine (112) and shared back on the social network (210) again by the Bot (206) or API (208). The device (102) or people (104) optionally find the processed result on the same social network (210) or emails (212). The bot (206) and/or API (208) plays a key and bridging role of linking the interactive engine and the core engine with in the new community watch process of the present disclosure.

FIG. 3 illustrates a preferred embodiment of the present disclosure; where the underlying high-level structure and data flow of the artificial intelligence and databases are presented. The bot (206) and the API (208) are the same as what was described in FIG. 2. The bot (206) handles the dialog-based conversation with users (104) to get data and outputs the results of the preprocessing to the collection and normalization (302) of the artificial intelligence and database (112). The API (208) takes the data input from the devices (102) and also outputs it to the collection and normalization (302) of the artificial intelligence and database (112).

The collection and normalization block (302) collects the media data and event data. It then normalizes the media data through equalization, color correction, noise removal, background extraction, and/or feature extraction; and the event data by converting it to the system standard formats, converting the timestamp to the universal time, and updating the severity score to conform to the system global standard instead of that of the individual device. The result of the processing of the collection and normalization block (302) is then fed to the input of the enrichment model (304).

The event data-enriching block (304) applies the facial recognition and behavior recognition algorithms to the inputted event data, and looks up the database to get the identity information (312). It also looks up the event data related to other information such as addresses, community details etc. from the threat intelligence database and processor (314). It applies categories based on event data attributes such as the types of devices, behaviors, outcomes, or significance, information, etc. It also filters and aggregates the event data. The result of the processing of the enrichment (304) is then fed into the input of the correlation model (306).

The event data correlation block (306) processes the data with correlation to discover the relationship between events and the intelligence knowledge of threats. It detects the potential threats and infers the significance of them, prioritizes them, then provides them to the framework for further actions. In one of the embodiments of the present disclosure, a threat severity score is evaluated using a predefined algorithm. For example, one of such predefined algorithms are, but are not limited to, (1) calculating the correlation scores between the inputted event data and a list of pre-known threats in the threat database; (2) reading the threat severity level of each pre-known threat from the database; (3) computing the weighted average of the threat severity levels based on their correlation scores with the inputted event data; the resulting weighted average can be used as the evaluated threat severity score of the event. The result of the processing of the correlation block (306) is then fed into the input of the monitoring model (308).

The event data monitoring (308) enables security operation centers to have the real-time situational awareness as events occur. The rule-based monitoring engine tracks the situations as they develop, and acts in a proactive manner. An Al based monitoring engine can help to predict criminal intentions without using pre-exist rules. The aggregation of meaningful physical security information allows for possible predictions of malicious behaviors such as breaking-and-entering, suspicious drive-bys, theft, terrorism, etc. The result of the processing of the monitoring (308) is then fed into the input of the response model (310).

The incident response block (310) creates the action workflow and alert or warning notifications based on the threat level. It sends the action commands, information, and/or warnings to reactive devices (102) or people (104) through the bot (206) and/or API (208). For example, if a high level threat is received, the incident response (310) will call 911 and/or broadcast to the community for actions to deter the malicious intentions.

FIG. 4 illustrates a preferred embodiment of the method or process of how the unified social network groups of the present disclosure are created. The key novelty of the present disclosure is a bot-centric information flow and the unified community watch social network groups. In the preferred embodiment of the present disclosure, the left side of FIG. 4 illustrates the interaction section (420) of the information flow. The right side of the FIG. 4 illustrates the fusion section (430) of the information flow. The integration section (400) links the interaction section (420) and the fusion section (430) by an X number of bots. The bots are from the first bot (406) to the Xth bot (408). Each bot may work on a specific type of functions of the whole process and on a specific social network platform only. Theses bots will convert the multiple streams of data from a group of actual community watch groups on the heterogeneous social network platforms to a single stream of data in the virtual unified community watch groups.

Let us assume there are M different social network platforms. For example, they are, but are not limited to, Facebook, Wechat, Twitter, Instagram, Snapchat, LinkedIn, and others. On the social network platform 1 (402), there exist N community watch groups that are from the community watch group 1 (410) to the community watch group N (412). Similarly, on the social network platform M (404), there also exists N community watch groups that are from the same community watch group 1 (410) to the community watch group N (412), wherein the social network platform 1 can be a completely different platform from the social network platform M in terms of hardware, software, and technologies used; while the same community watch group 1 (410) or community watch group N (412) may reside simultaneously across from the social network platform 1 to the social network platform M, as well as any other social network platforms between 1 and M. Under this situation, if a community watch group user wants to communicate with another user in the same community watch group that is on a different social network platform, one of the two users has to switch to the same community watch group on the same social network platform as the other user. This is a lot of work if not impractical. Furthermore, a user of a community watch group on a specific social network platform cannot receive warnings from any user of the same community watch group on other different social network platforms.

We use a novel fusion process (400) to create the unified community watch groups or social network groups from the heterogeneous underlying social network platforms, where the unified community watch groups are created along with the unified social network groups. As shown in the fusion section (430), the newly created unified community watch group 1 (414) works on the newly created unified social network group 1; the unified social network group 1 contains the users and data of the social network platform 1 (402) and that of the social network platform M (404). The newly created community watch group N (416) also works on the newly created unified social network group N; the unified social network group N contains the users and data of the social network platform 1 (402) and that of the social network platform M (404). The fusion process carried out by the bots (406, 408) will be working as per the following steps.

First, all the bots (406, 408) in the integration section (400) will collect all messages, event notifications, and other social network information from all community watch groups on all social network platforms. The messages here include, but are not limited to vocal, visual, audio, text, or binary data messages. Then they will fuse all contents from the same community watch group together from the multiple chat threads on the different social network platforms into one stream of conversation for the community watch group. The resulting single stream of data will be processed in the virtual unified community watch groups by the bots. The bots will also track and remember the users, community watch groups and social network platforms via correspondent mapping so they can relay the future messages to the correct users.

Next the bots (406, 408) need to distribute the fused single stream of conversation back to the community watch groups in the various social network platforms. For example, considering all users in the community watch group 1 (410), if a first user A is on the social network platform 1 (402); a second user B is on the social network platform 2; and a third user C is on the social network platform M (404). When user A sends out a message, the bots (406, 408) detect and collect the message. The bots (406, 408) look up their tracking and mapping database and know that the user B and user C are also in the same community watch group, so they need to receive this message. In an existing traditional community watch group, user B and user C have no way to be notified and communicate with user A. Now, in the new community watch of the present disclosure, the bots will post the message from A, to user B and C who are in the same virtual unified community watch group as user A but are on the different social network platforms.

Then if either user B or C replies to the message, the bots will know how to send the reply back to the user A. In this way, the difference between the underlying social network platforms is transparent to all users, and this greatly empowers the new community watch program's functions and improves the ease of use.

Yet in another alternative embodiment of the present disclosure extended further from the FIG. 4, a number of the neighborhood groups at the different levels could be nested in a tree structure. A root neighborhood group may branch into multiple sub-community watch groups over multiple social network platforms. One sub-community watch group may also contain several leaf community watch groups. The bots (406, 408) will now be responsible for flattening the nested tree structure of the messages into a single level conversion in the virtual unified group, and vise versa.

In the above embodiment of the present disclosure, a neighborhood community is a forest of the tree structures of community watch groups. The backend services behind the bots correlate the events based on neighborhood community information and carry out the event data fusion during data processing, monitoring and response. They put the event data from multiple neighborhood groups and multiple social network platforms into one neighborhood group context. Actions such as notifications or instructions to the root neighborhood group are dispatched to all belonging neighborhood groups across all the social network platforms.

There are two scenarios for a specific community watch: the first being a community watch that has multiple groups in one social network platform, where we will only need one type of bot to integrate and merge into one root level neighborhood group. The second is a neighborhood that has groups in two or more social network platforms, with one or more groups in each social network platform. In this case, we need multiple types of bots to integrate and merge conversation information into one root level neighborhood group.

In an alternative embodiment of the present disclosure, the new community watch process can also join the community watch groups together based on their geo-location information instead of their group names. For example, the community watch group 1 (410) on the social network platform (402) has a closer physical location with the community watch group N (412) on the social network platform M (404) than the community watch group 1 (410) on the social network platform M (404). So the community watch group 1 (410) on the social network platform (402) may be fused with the community watch group N (412) on the social network platform M (404) to become a virtual unified community watch group 1 (414). It is obvious to the ordinarily skilled in the art that many other combinations of the fusion criteria, like but not limited to the time, user demography, community types, etc. can be used here to instruct the bots (406 to 408) to integrate and merge the conversation information into one virtual unified community watch group. The similar process also enables the sharing of physical threat-intelligent information across community watch groups in separate geographical locations.

FIG. 5 illustrates an exemplary preferred embodiment of the data and processing flow of the artificial intelligent engine and its databases of the present disclosure. The data flow chart starts with an image or video that is uploaded to the core engine (112). If it is an image (502), an image id, uploader id, and the timestamp of uploading time are recorded along with the image in the database. If it is a video (504), a video id, uploader id, and the timestamp of uploading time are recorded along with the video in the database. The backend artificial intelligence (AI) program will process the input media in the block (506). If there is a person in the image or video, the AI program will determine the top left coordinates and size of the person's face in both horizontal and vertical directions (topLeftX, topLeftY, width, height). The AI program will also detect the distance between two eyes in terms of pixels and the coordinates of each eye's center. The behavior detection intelligence of the core engine will also try to recognize the person's behavior type according the threat intelligence database and record the results. Finally, the program also records the geo-location information of the event and the timestamp of the analysis. Next to the analysis in (506), the AI engine will further recognize and determine the higher level behavior category in (508) based on the inputted information such as the community, geo-location, social network behavior, identity database, etc. The processing result and timestamp in block (508) are then send to block (510). In block (510), the program works to generate conversation workflows, notifications to users, commands to the bats (206, 208), as well as timestamp of the processing. Finally the outputs of the block (510) are sent to the bots (206) and/or API (208) to be sent back to users (104), devices (102), or other platforms (106).

FIG. 6 illustrates an exemplary embodiment of the block diagram of the core engine of the present disclosure. In the core engine (602), there is a white list (604) and a black list (606). The white list (604) is a database that contains person identities that are confirmed to be safe and secure. The black list (606) is a database that contains person identities that are confirmed to be dangerous and unsecure. The complex rules block (608) is a database that contains heuristic intelligence rules or rules proven by previously successful tests, studies, systems and/or machine learning, and training results. The threat intelligence (610) is a database and processor that can be used to detect a potential threat from a set of information provided including images, videos, historical behavior patterns and sequences. This can be third party databases or systems from the police, government, or other companies. The rule engine (612) is a procedure processor used to execute the intelligence using the white list (604), black list (606), complex rules (608) and the results generated from the threat intelligence (610). The AI block (614) is an artificial intelligence processor to execute the intelligence using the white list (604), black list (606), complex rules (608) and the results generated from the threat intelligence (610). The rule engine (612) and the AI processor (614) can run independently or complementarily to get the best result. The rule-based engine (612) is an example of “old-style” AI, which uses rules prepared by humans. A.I. neural network (614) is example of “new-style” AI, whose mechanism is “learned” by the computer using sophisticated algorithms, and as a result, we humans don't really understand why it works. While in some cases rule-based systems could be effective, the general trend in AI has been to switch to machine-learning algorithms such as neural networks, due to their much better performance.

In an alternative embodiment of the present disclosure, the AI engine (614) can be a deep learning engine. Deep learning (also known as deep structured learning or hierarchical learning) is part of a broader family of machine learning methods based on learning data representations, as opposed to task-specific algorithms. Learning can be supervised, semi-supervised or unsupervised. In deep learning, each level learns to transform its input data into a slightly more abstract and composite representation. In an image recognition application, the raw input may be a matrix of pixels; the first representational layer may abstract the pixels and encode edges; the second layer may compose and encode arrangements of edges; the third layer may encode a nose and eyes; and the fourth layer may recognize that the image contains a face. More importantly, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feed forward neural network, the depth of the CAPs is that of the network and is the number of hidden layers plus one (as the output layer is also parameterized). For recurrent neural networks, in which a signal may propagate through a layer more than once, the CAP depth is potentially unlimited. No universally agreed upon threshold of depth divides shallow learning from deep learning, but most researchers agree that deep learning involves CAP depth >2. CAP of depth 2 has been shown to be a universal approximator in the sense that it can emulate any function. Beyond that more layers do not add to the function approximator ability of the network. The extra layers help in learning features.

1. A method for an online community watch, comprising:
configuring a virtual community watch group that includes a first, second, third, and fourth member;
wherein the first and second members are users of a first social network group on a first platform; the third and fourth members are users of a second social network group on a second platform; wherein the platforms include hardware and software;
wherein all the members are geographically proximate to each other;
wherein the first member shares a message in the first social network group;
providing a first and second bot in the first and second social network groups as a user, respectively;
wherein the first bot scans and processes the message using a first application programming interface (API), wherein the processing comprises:
analyzing the message content against a database;
determining a security category, severity score, and action option;
wherein the action option comprises:
placing an online call to police; or
activating a physical event, or
sending a security message to the second bot and the first and second members;
triggering the action option using a second application programming interface (API);
wherein the second bot sends the security message, if any, to the third and fourth members.

2. The method of claim 1, wherein the member may be a system, device, person, software application, or social network bot.

3. The method of claim 2, wherein the system can be said virtual community watch group.

4. The method of claim 1, wherein the platforms run on different internet, telephony or cellular communication infrastructures.

5. The method of claim 1, wherein each social network group may have more than one social network bot that serve different and independent functions.

6. The method of claim 1, wherein the severity score is a measurement reflecting the severity level of the determined security category.

7. The method of claim 1, wherein the shared message may be images, videos, audio, text, lights, or other formats of signals.

8. The method of claim 1, wherein the artificial intelligence includes rule-based intelligence and machine learning based artificial intelligence.

9. The method of claim 8, wherein the machine learning is deep machine learning.

10. The method of claim 1, wherein the message processing also includes collection, normalization, enrichment, correlation, monitoring, and response.

11. The method of claim 10, wherein the enrichment uses an identity database.

12. The method of claim 10, wherein the correlation, monitoring, or response uses a threat intelligence database.

13. The method of claim 1, wherein the message processing additionally uses a white list and a black list.

14. The method of claim 1, wherein the message processing includes facial recognition or human behavior pattern recognition.

15. The method of claim 1, wherein the database additionally includes third-party databases or systems from the police, the government, or companies.

16. A system of an online community watch, comprising:
a first and second social network group on a first and second platform, respectively;
wherein the platforms include hardware and software;
a virtual community watch group that includes a first, second, third, and fourth member;
wherein the first and second members are users of the first social network group;
the third and fourth members are users of the second social network group;
wherein all the members are geographically proximate to each other;
wherein the first member shares a message in the first social network group;
a first and second bot in the first and second social network groups as a user, respectively;
a processor in the first bot that scans and processes the message using a first application programming interface (API), wherein the processing comprises:
analyzing the message content against a database;
determining a security category, severity score, and action option;
wherein the action option comprises:
placing an online call to police; or
activating a physical event, or
sending a security message to the second bot and the first and second members;
triggering the action option using a second application programming interface (API);
a processor in the second bot that sends the security message if any to the third and fourth members.

17. the system of claim 16, wherein the member may be a system, device, person, software application, or social network bot.

18. the system of claim 17, wherein the system can be said virtual community watch group.

19. the system of claim 16, wherein the platforms run on different internet, telephony or cellular communication infrastructures;
wherein each social network group may have more than one social network bot that serve different and independent functions.
wherein the shared message may be images, videos, audio, text, lights, or other formats of signals.

20. The system of claim 16,
wherein the severity score may be a measurement reflecting the severity level of the determined security category.
wherein the message processing may also include collection, correlation, monitoring and response using an identity, threat intelligence, white and black list, and/or third-party database;
wherein the artificial intelligence may include rule-based and machine learning based intelligence; wherein the machine learning based intelligence may include deep machine learning, facial recognition, and human behavior pattern recognition.
